(19) United States
(12) Patent Application Publication
(10) Pub. No.: US 2025/0239038 A1
(43) Pub. Date: Jul. 24, 2025

(54) Controllable and Temporally Coherent Neural Mesh Stylization

(71) Applicant: Disney Enterprises, Inc., Burbank, CA (US)

(72) Inventors: Vinicius Da Costa De Azevedo, Zurich (CH); Guilherme Gomes Haetinger, Porto Alegre (BR); Jingwei Tang, Horgen (CH); Raphael François Ortiz, Dübendorf (CH); Paul Kanyuk, Berkeley, CA (US)

(21) Appl. No.: 19/035,318

(22) Filed: Jan. 23, 2025

Related U.S. Application Data
(60) Provisional application No. 63/624,678, filed on Jan. 24, 2024.

(51) Int. Cl. G06T 19/20; G06T 15/20; G06T 17/20

(52) U.S. Cl. CPC G06T 19/20; G06T 15/20; G06T 17/20; G06T 2200/24; G06T 2219/2024

(57) ABSTRACT

A system includes a hardware processor and a memory storing software code and a style transfer machine learning (ML) model. The hardware processor is configured to execute the software code to receive an image and a style sample of a selected stylization for an original surface mesh depicted by the image, perform a view-independent reparametrization of the original surface mesh to provide a reparametrized surface mesh, render a three-dimensional (3-D) representation of the reparametrized surface mesh, and generate, using a plurality of virtual cameras, a plurality of perspective images of the 3-D representation. The hardware processor is further configured to execute the software code to stylize, using the style transfer ML model, the style sample and the plurality of perspective images of the 3-D representation, the original surface mesh, to provide a stylized version of the original surface mesh having the selected stylization.

### RELATED APPLICATION(S)

The present application claims the benefit of and priority to a pending U.S. Provisional Patent Application Ser. No. 63/624,678 filed on Jan. 24, 2024, and titled “A Controllable and Temporally Coherent Neural Mesh Stylization,” which is hereby incorporated fully by reference into the present application.

### BACKGROUND

Since the advent of the first three-dimensional (3-D) animated movie, i.e., Toy Story, a sophisticated set of tools for modeling, animating and rendering assets has been developed. A recent industry trend has been to favor more stylized depictions over realistic representations, in order to support storytelling. This preference has prompted the development of additional tools that can support new design techniques. Among these recent techniques, image-based stylization of 3-D assets allows artists to achieve new unique looks.

However, conventional approaches to performing image-based stylization of 3-D assets tend to focus on volumetric data, to focus on static meshes, or they fail to provide artistic control and are therefore unsuitable for direct incorporation into animation and visual effects (VFX) pipelines. Moreover, conventional mesh appearance modelling techniques tend to be restricted to closely following the surface of the input mesh, or to be solely focused on texture synthesis. Thus, there remains a need in the art for a mesh stylization technique capable of producing sharp, temporally-coherent and controllable stylizations of dynamic meshes.

### BRIEF DESCRIPTION OF THE DRAWINGS

FIG. 1 shows an exemplary system for performing controllable and temporally coherent neural mesh stylization, according to one implementation;

FIG. 2 shows a conceptual diagram of a processing pipeline for performing controllable and temporally coherent neural mesh stylization, according to one implementation;

FIG. 3 shows a flowchart presenting an exemplary method for performing controllable and temporally coherent neural mesh stylization, according to one implementation;

FIG. 4 shows the effects of different exemplary parametrization smoothing weights on resultant surface mesh stylizations, according to various implementations; and

FIG. 5 presents exemplary pseudocode of an algorithm for performing controllable and temporally coherent neural mesh stylization, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing controllable and temporally coherent neural mesh stylization. As stated above, conventional approaches to performing image-based stylization of three-dimensional (3-D) assets tend to focus on volumetric data, to focus on static meshes, or they fail to provide artistic control and are therefore unsuitable for direct incorporation into animation and visual effects (VFX) pipelines. Moreover, conventional mesh appearance modelling techniques tend to be restricted to closely following the surface of the input mesh, or to be solely focused on texture synthesis.

The novel and inventive approach disclosed by the present application addresses and overcomes the drawbacks and deficiencies in the conventional art by enabling the production of sharp, temporally-coherent and controllable stylizations of dynamic meshes. The neural mesh stylization solution disclosed herein can seamlessly stylize assets depicting cloth and liquid simulations, while also advantageously enabling detailed control over the evolution of the stylized patterns over time.

It is noted that the neural mesh stylization solution disclosed by the present application advances the state-of-the-art in several ways. First, the present solution replaces the conventional Gram-Matrix-based style loss by a neural neighbor formulation that provides sharper and artifact-free results. In order to support large mesh deformations, the mesh positions of an input mesh undergo a view-independent reparametrization, according to the present solution, through an implicit formulation based on the Laplace-Beltrami operator to better capture silhouette gradients commonly present in inverse differentiable renderings. This view-independent reparametrization is coupled with a coarse-to-fine stylization, which enables deformations that can change large portions of the mesh. Furthermore, although artistic control is one of the often overlooked aspects of image-based stylization, the neural mesh stylization solution disclosed herein enables control over synthesized directional styles on the mesh by a guided vector field. This is achieved by augmenting the style loss with multiple orientations of the style sample, which are combined with a screen-space guiding field that spatially modulates which style direction should be used. In addition, the present solution improves conventional time-coherency schemes by developing an efficient regularization that controls volume changes during the stylization process. These improvements advantageously enable novel mesh stylizations that can create unique looks for simulations and 3-D assets.

It is further noted that the present solution for performing controllable and temporally coherent neural mesh stylization can be implemented as automated systems and methods. As defined in the present application, the terms “automation,” “automated” and “automating” refer to systems and processes that do not require the participation of a human system operator. Thus, the methods described in the present application may be performed under the control of hardware processing components of the disclosed automated systems.

It is also noted that the present approach implements one or more trained style transfer machine learning (ML) models (hereinafter “style transfer ML model(s)”), which, once trained, are very efficient, and can provide stylizations quickly and efficiently. Moreover, the complexity involved in providing the stylizations disclosed in the present application requires such style transfer ML model(s) because human performance of the present mesh stylization solution in feasible timeframes is impossible, even with the assistance of the processing and memory resources of a general purpose computer.

As defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as Transformers, large language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

The present neural mesh stylization solution may be used to stylize a variety of different types of content. Examples of the types of content to which the present solution for neural mesh stylizations may be applied include simulations of volumetric objects, simulations of cloth, and simulations of liquids, for example. Such content may be depicted by a sequence of images, such as video. Moreover, that content may be depicted as one or more simulations present in a real-world, virtual reality (VR), augmented reality (AR), or mixed reality (MR) environment. Furthermore, that content may be depicted as present in virtual worlds that can be experienced by any number of users synchronously and persistently, while providing continuity of data such as personal identity, user history, entitlements, possessions, payments, and the like. It is noted that the solution for performing controllable and temporally coherent neural mesh stylization disclosed by the present application may also be applied to content that is depicted by a hybrid of traditional audio-video and fully immersive VR/AR/MR experiences, such as interactive video.

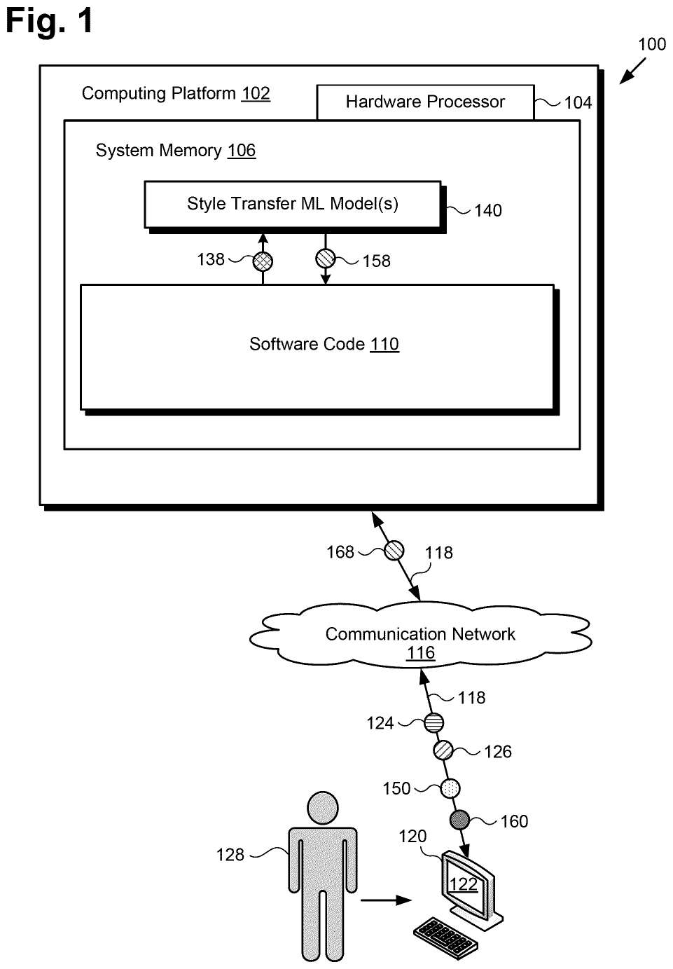

FIG. 1 shows an exemplary system for performing controllable and temporally coherent neural mesh stylization, according to one implementation. As shown in FIG. 1, system 100 includes computing platform 102 having hardware processor 104 and system memory 106 implemented as a computer-readable non-transitory storage medium. According to the present exemplary implementation, system memory 106 stores software code 110 and style transfer ML model(s) 140. In some examples, style transfer ML model(s) 140 may be NNs.

As further shown in FIG. 1, system 100 is implemented within a use environment including communication network 116, client system 120 including display 122, and user 128 of system 100 and client system 120, who may be an artist for example. In addition, FIG. 1 shows image 124, style sample 126 of a selected stylization for an original surface mesh depicted by image 124, and image 168 depicting a stylized version of the original surface mesh, the stylized version having the selected stylization. That is to say, an original surface mesh depicted by image 124 is stylized according to style sample 126 by system 100, and image 168 depicting the desired stylization is output by system 100 to client system 120. Also shown in FIG. 1 are plurality of perspective images 138 of a 3-D representation of the original surface mesh after the original surface mesh is reparametrized as described below, stylization 158 selected for transfer to the original surface mesh, optional flow field data 140 and masking data 160 received by system 100 from user 128 of client system 120, and network communication links 118 of communication network 116 interactively connecting system 100 and client system 120.

Although the present application refers to software code 110 and style transfer ML model(s) 140 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (POS) protocol, rather than the more energy intensive proof-of-work (PoW) protocol.

Although FIG. 1 depicts software code 110 and style transfer ML model(s) 140 as being co-located in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system or blockchain, for instance. As a result, hardware processor 104 and system memory 106 may correspond to distributed processor and memory resources within system 100. Consequently, in some implementations, software code 110 and style transfer ML model(s) 140 may be stored remotely from one another on the distributed memory resources of system 100. It is also noted that, in some implementations, some or all of style transfer ML model(s) 140 may take the form of one or more software modules included in software code 110.

Hardware processor 104 may include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for artificial intelligence processes such as machine learning.

In some implementations, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth®, for instance. Furthermore, in some implementations, system 100 may be implemented virtually, such as in a data center. For example, in some implementations, system 100 may be implemented in software, or as virtual machines. Moreover, in some implementations, communication network 116 may be a high-speed network suitable for high performance computing (HPC), for example a 10 GigE network or an Infiniband network.

It is further noted that, although client system 120 is shown as a desktop computer in FIG. 1, that representation is provided merely by way of example. In other implementations, client system 120 may take the form of any suitable mobile or stationary computing device or system that implement data processing capabilities sufficient to provide a user interface, support connections to communication network 116, and implement the functionality ascribed to client system 120 herein. That is to say, in other implementations, client system 120 may take the form of a laptop computer, tablet computer, or smartphone, to name a few examples. In still other implementations, client system 120 may be a peripheral device of system 100 in the form of a dumb terminal. In those implementations, client system 120 may be controlled by hardware processor 104 of computing platform 102.

It is also noted that display 122 of client system 120 may take the form of a liquid crystal display (LCD), a light-emitting diode (LED) display, an organic light-emitting diode (OLED) display, a quantum dot (QD) display, or any other suitable display screen that perform a physical transformation of signals to light. Furthermore, display 122 may be physically integrated with client system 120 or may be communicatively coupled to but physically separate from client system 120. For example, where client system 120 is implemented as a smartphone, laptop computer, or tablet computer, display 122 will typically be integrated with client system 120. By contrast, where client system 120 is implemented as a desktop computer, display 122 may take the form of a monitor separate from client system 120 in the form of a computer tower.

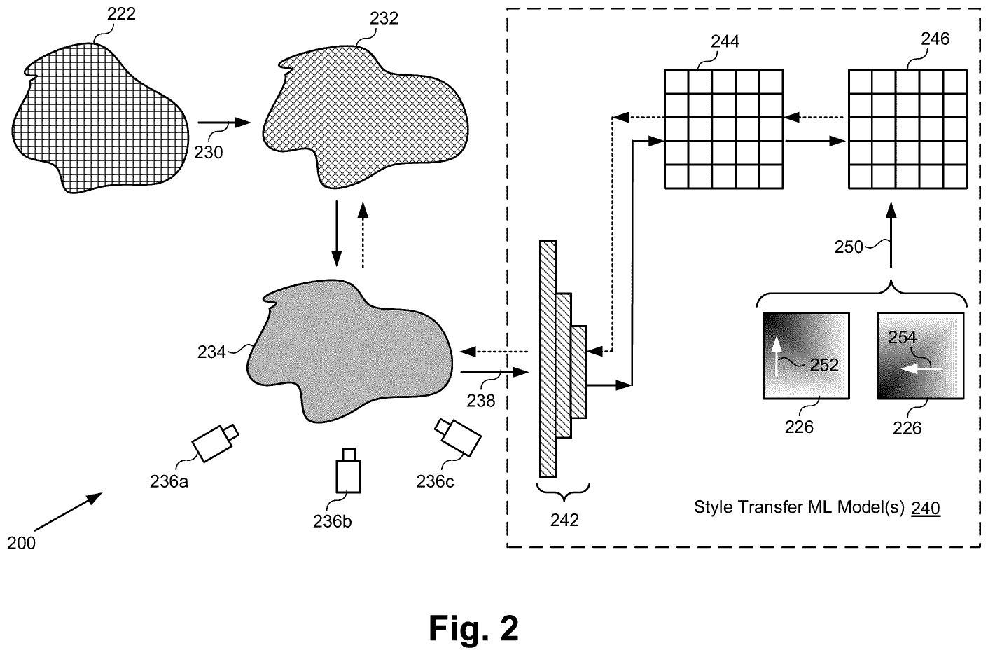

FIG. 2 shows a conceptual diagram of processing pipeline 200 for performing controllable and temporally coherent neural mesh stylization, according to one implementation. It is noted that processing pipeline 200 may be implemented using software code 110 of system 100, in FIG. 1, in combination with style transfer ML model(s) 140.

As shown in FIG. 2, processing pipeline 200 may include original surface mesh 222 after optimization of the mesh vertices of original surface mesh 222 has been performed, view-independent reparametrization 230 of original surface mesh 222 to provide reparametrized surface mesh 232, rendered 3-D representation 234 of reparametrized surface mesh 232, virtual cameras 236a, 236b and 236c (hereinafter “virtual camera(s) 236a-236c”), plurality of perspective images 238 of 3-D representation 234, which may be Poisson-distributed perspective images for example, generated using virtual cameras 236a-236c, and style transfer ML model(s) 240. As further shown in FIG. 2, style transfer ML model(s) 240 may include one or more pre-trained NNs 242 (hereinafter “pre-trained NN(s) 242”), which may be or include one or more convolutional NNs (CNNs) for example, original features 244 included in plurality of perspective images 238, stylized features 246 for original surface mesh 222 determined using pre-trained NN(s) 242, and optional flow field data 250 identifying screen-space orientation fields, for example, each specifying a different planar orientation of style sample 226, e.g., planar orientations 252 and 254.

It is noted that style sample 226, plurality of perspective images 238, style transfer ML model(s) 240 and flow field data 250 correspond respectively in general to style sample 126, plurality of perspective images 138, style transfer ML model(s) 140 and flow field data 150, in FIG. 1. Consequently, style sample 126, plurality of perspective images 138, style transfer ML model(s) 140 and flow field data 150 may share any of the characteristics attributed to respective style sample 226, plurality of perspective images 238, style transfer ML model(s) 240 and flow field data 250 by the present disclosure, and vice versa. It is further noted that although FIG. 2 depicts three virtual cameras 236a-236c and two different planar orientations 252 and 254 of style sample 226, those representations are merely provided as examples. In various implementations, virtual cameras 236a-236c may include as few as two virtual cameras, or more than three virtual cameras, while in other implementations more than two different planar orientations of style sample 226 may be included in optional flow field data 250.

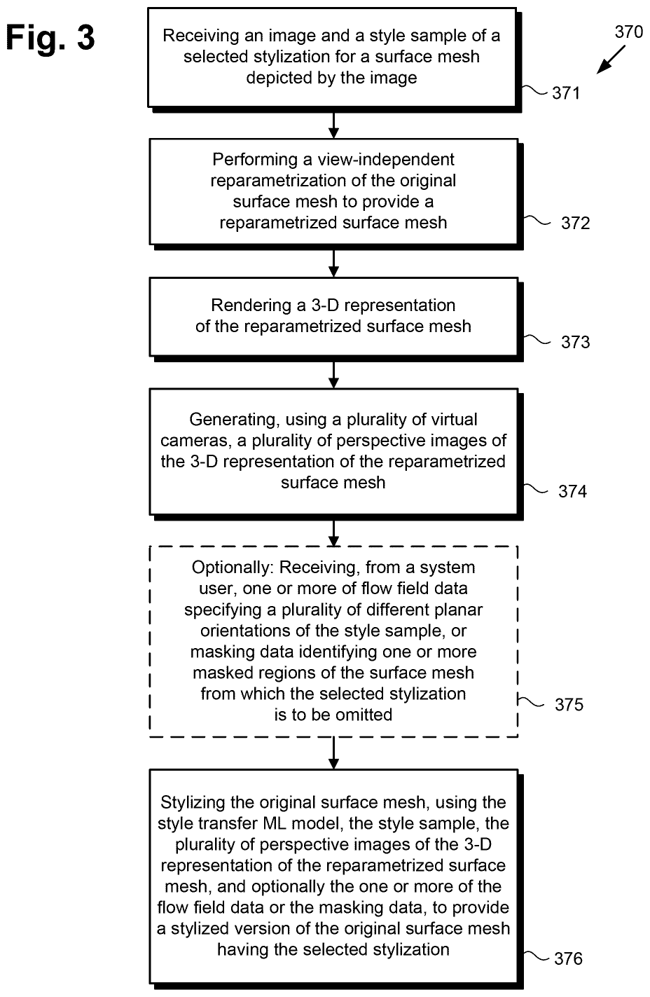

The functionality of system 100 including software code 110 and style transfer ML model(s) 140/240, will be further described by reference to FIG. 3, which shows flowchart 370 presenting a method for performing controllable and temporally coherent neural mesh stylization, according to one implementation. With respect to the actions described in FIG. 3, it is noted that certain details and features have been left out of flowchart 370 in order not to obscure the discussion of the inventive features in the present application.

Referring to FIG. 3 in combination with FIGS. 1 and 2, flowchart 370 includes receiving image 124 and style sample 126/226 of a selected stylization for original surface mesh 222 depicted by image 124 (action 371). Image 124 may be a two-dimensional (2-D) image such as a video frame, for example, depicting original surface mesh 222. Content depicting original surface mesh 222 in image 124 may include simulations of volumetric objects, as well as simulations of cloth and liquids, for example. Moreover, and as noted above, content in image 124 may include one or more simulations present in a real-world, VR, AR, or MR environment, and may be depicted as present in virtual worlds that can be experienced by any number of users synchronously and persistently, while providing continuity of data such as personal identity, user history, entitlements, possessions, payments, and the like.

Style sample 126 may include any of a large number of parameters. Examples of parameters that may be included in style sample 126 are image size, which layers of an NN included in style transfer ML model(s) 140 will be used to produce the selected stylization 158, how many iterations will be performed, and the learning rate, to name a few. Image 124 and style sample 126 of the selected stylization for original surface mesh 222 depicted by image 124 may be received, in action 371, by software code 110, executed by hardware processor 104 of system 100.

Continuing to refer to FIGS. 1, 2 and 3 in combination, flowchart 370 further includes performing a view-independent reparametrization of original surface mesh 222 to provide reparametrized surface mesh 232 (action 372). View-independent reparametrization 230 of original surface mesh 222 to provide reparametrized surface mesh 232 may be performed by software code 110, executed by hardware processor 104 of system 100.

By way of overview, and as also discussed below, according to the present neural mesh stylization solution: 3-D asset renders are generated by a differentiable renderer through a set of Poisson-distributed perspective images 138/238 to obtain an image-space loss function. This loss function is minimized with respect to the mesh vertex positions of original surface mesh 222(x) to obtain a stylized look. This is expressed by:

$$\hat{x} = \begin{matrix}arg min \\ x\end{matrix} {\sum }_{θ ∼ Θ} {L}_{s} ( {R}_{θ} ( x ) , {I}^{s} ) , \qquad ( Equation 1 )$$

where [symbol] is a differentiable renderer with a virtual camera setup θ sampled from a distribution Θ of all possible configurations. The style loss ( [symbol] ₛ) receives the rendered ( [symbol] ^{θ}(x)) and style sample (I^{s}) images to evaluate the style matching objective. The stylization process is also required to ensure that the content of the generated image matches the original input. This is implemented either by initializing the optimization with the original image and making sure that the optimized variable is bounded, or by using additional content losses. The present neural mesh stylization solution initializes the stylized mesh to be original surface mesh 222 in processing pipeline 200.

Central to an efficient stylization is a dimensionality reduced image representation that will allow the decomposition of the image into its representative elements. Image features are typically computed through feature activation maps from a pre-trained classification network such as the Visual Geometry Group (VGG) model or Inception model, for example. The style of an image is then extracted by computing the secondary statistics of those features. In the conventional art, the Gram matrix models perform correlations through a dot product between channels of a single classification network layer. However, the performance of Gram matrices can be subpar when used with surface mesh style transfer. The problem arises when synthesizing high-frequency details: the Gram matrix optimization can guide the result to focus on correlations that are not relevant in smaller scales. This creates a “washed out” stylization that converges to a local minima where high-frequency details are mixed or not clearly visible.

The neural neighbor style transfer implemented in the present neural mesh stylization solution avoids this deficiency introduced by Gram matrices by first spatially decomposing the content and style sample images into feature vectors, and then replacing each individual content feature vector with its closest style sample feature through a nearest neighbor search. This generates a set of style sample features that preserve the layout of the original image, allowing the optimization to process image corrections that can synthesize high-frequency details. The neural neighbor stylization defines the style loss as the cosine distance, D_{cos}, between the replaced features and the feature to be optimized as:

$${L ( I , {I}^{s} )}_{s} = \frac{1}{N} {\sum }_{i = 1}^{N} {D}_{cos} ( N ( F ( {I}_{i} ) , F ( {I}^{s} ) ) , F ( {I}_{i} ) ) , \qquad ( Equation 2 )$$

where [symbol] is the zero-centered feature extraction network, [symbol] is the function that replaces the features of a given i-th pixel of the image to be optimized Iᵢ with the nearest neighbor feature on the style sample image I^{s}, and N is the number of pixels of the image to be optimized I.

According to the present neural mesh stylization solution, Equation 2 is plugged into Equation 1 with I= [symbol] _{θ}(x), and mesh vertices are optimized such that at each iteration the cosine distance between the zero-centered extracted features of the rendered mesh and the style sample image are minimized.

Another important aspect of the present neural mesh stylization solution is the decomposition of the stylization into multiple levels, enforcing a coarse-to-fine optimization process. Naively optimizing a multi-scale image-space loss function, i.e., Equation 1, however, is not enough to modify large structures of the surface mesh. This is because geometric gradients in differentiable renderings contain sparse values stemming from silhouette modifications. Despite having large values, these silhouette gradients are not able to significantly modify large structures of the surface mesh due to the sparsity of the silhouette gradients.

As a result, the optimization process is susceptible to being limited to creating small scale structures that are overly restricted to the mesh surface. To avoid this undesirable outcome, the present solution includes reparametrizing the optimized positions of Equation 1 through an implicit formulation using the Laplace-Beltrami operator, L, as:

$${x}^{*} = ( 1 + λ L ) x , \qquad ( Equation 3 )$$

where I is the identity matrix and λ is a weighting factor to control the smoothness of the reparametrization. This reparametrization effectively modifies the gradient in each optimization step as:

$${x}^{*} ← {x}^{*} - {η ( I - λ L )}^{- 1} \frac{\partial L}{\partial {x}^{*}} , \qquad ( Equation 4 )$$

with η being the learning rate. The effect of reparametrizing the surface mesh positions using Equation 3 is that the sparse silhouette gradients as well as the image-space modifications are diffused to larger regions of the surface mesh during a backpropagation step.

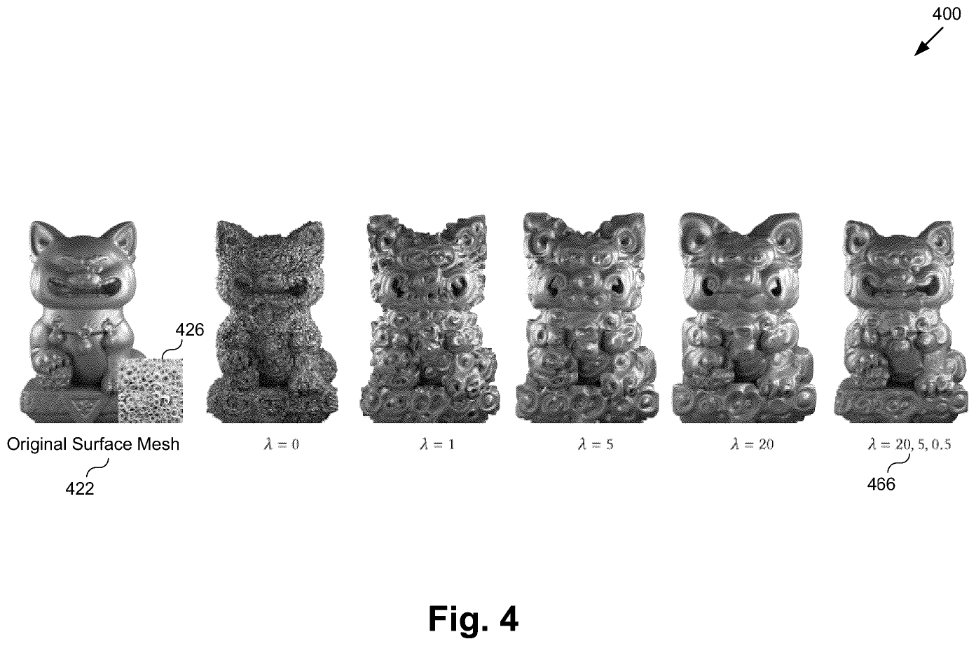

FIG. 4 shows the effects of different exemplary reparametrization smoothing weights, λ, on resultant stylization of original surface mesh 422 based on style sample 426. It is noted that original surface mesh 422 and style sample 426 correspond respectively in general to original surface mesh 222 and style sample 126/226 shown variously in FIGS. 1 and 2. Consequently, original surface mesh 422 and style sample 426 may share any of the characteristics attributed to original surface mesh 222 and style sample 126/226 by the present disclosure. As shown in FIG. 4, with λ=0, the optimization process is unable to modify large structures of original surface mesh 422 and the stylization becomes uncoordinated noise. As further shown in FIG. 4, increasing the value of λ, i.e., λ=1, λ=5, λ=20, enables increasingly coarser surface mesh stylizations.

In order to better synthesize structures at different scales, the present neural mesh stylization solution implements a coarse-to-fine strategy that receives as input image 124 and style sample 126/226/426, and optimizes images with the smallest size as the first level. The output of each coarse level stylization serves as the initialization of the next finer level. This approach also leverages the influence of the reparametrization described by Equation 3. As progress to finer levels occurs, the value of the reparametrization smoothing weight, A, is decreased, resulting in more local, detailed stylizations. Example 466, in FIG. 4, shows the advantage of using different values of λ, i.e., λ=20, λ=5, λ=0.5 at progressively lower/higher levels of coarseness/fineness to create a stylized result that can modify large scale structures and small scale details of original surface mesh 422.

Referring once again to FIGS. 1, 2 and 3 in combination, flowchart 370 further includes rendering 3-D representation 234 of reparametrized surface mesh 232 (action 373). As noted above, 3-D representation 234 of reparametrized surface mesh 232 may be produced using a differentiable renderer. The rendering of 3-D representation 234 of reparametrized surface mesh 232, in action 373, may be performed by software code 110, executed by hardware processor 104 of system 100.

Continuing to refer to FIGS. 1, 2 and 3 in combination, flowchart 370 further includes generating, using plurality of virtual cameras 236a-236c, plurality of perspective images 138/238 of 3-D representation 234 of reparametrized surface mesh 232 (action 374). As noted above, plurality of perspective images 138/238 may be or include a set of Poisson-distributed perspective images, which may be used to obtain an image-space loss function which is minimized with respect to the mesh vertex positions of original surface mesh 222, as expressed by plugging Equation 2 into Equation 1. Plurality of perspective images 138/238 may be generated, in action 374, by software code 110, executed by hardware processor 104 of system 100.

Continuing to refer to FIGS. 1, 2 and 3 in combination, in some implementations, flowchart 370 may further include receiving, from user 128 of system 100 and client system 120, one or more of flow field data 150/250 specifying plurality of different planar orientations 252 and 254 of style sample 126/226, or masking data 160 identifying one or more masked regions of original surface mesh 222 from which selected stylization 158 is to be omitted (action 375). It is noted that action 375 is optional, and in some implementations, system 100 may receive neither of flow field data 150/250 or masking data 160, may receive one of flow field data 150/250 or masking data 160, but not both, or may receive both of flow field data 150/250 and masking data 160. In implementations in which optional action 375 is omitted from the method outlined by flowchart 370, action 376 described below may follow directly from action 374. In implementations in which optional action 375 is included in the method outlined by flowchart 370, optional action 375 may be performed by software code 110, executed by hardware processor 104 of system 100. Moreover, it is further noted that when performed, optional action 375 may precede any or all of actions 371, 372, 373, or 374, may follow any or all of actions 371, 372, 373, or 374, or may be performed in parallel with, i.e., contemporaneously with, any of actions 371, 372, 373, or 374.

With respect to flow field data 150/250, one of the often overlooked aspects of incorporating mesh stylization into animation processing pipelines is that some style samples have directional features relevant to the final result. For example, a style sample having a distinctive directional component, if used naively to stylize a surface mesh, can undesirably result in stylized patterns being synthesized in arbitrary directions. The present neural mesh stylization solution introduces two optional modifications that allow the present technique to be better oriented given an input orientation field. First, the neural neighbor style loss may be augmented by rotating style sample 126/226 into several different orientations 252 and 254. Each rotated style sample 126/226 is associated with a directional vector that indicates the orientation of style sample 126/226. Second, a user-specified orientation vector field may be defined on original surface mesh 222. The directional vectors can then be combined with a screen-space orientation field to compute a set of per-pixel weights associated with each rotated style sample.

A simplified rendering process may be employed for the orientation field: e.g., the user-specified orientation vectors may be mapped to red-green-blue (RGB) components of a textured surface mesh, and then rendered with a flat shading and no lights for each virtual camera view. This simplified rendering still considers occlusions, so only visible orientation fields will be projected to the screen-space. These 2-D orientation vectors can then be combined with the directional vectors of the rotated style samples through a dot product, creating several per-pixel masks that serve as weights for the style losses represented by the rotated style samples.

Regarding masking data 160, the present neural mesh stylization solution also allows the input of a user-specified mask, identified by masking data 160, to prevent a specific region from being stylized. This provides not only the artistic control of synthesized style features, but also volume conservation on thin regions of the surface mesh.

Continuing to refer to FIGS. 1, 2 and 3 in combination, flowchart 370 further includes stylizing original surface mesh 222, using style transfer ML model(s) 140/240, style sample 126/226, plurality of perspective images 138/238 of 3-D representation 234 of reparametrized surface mesh 232, and optionally one or both of flow field data 150/250 and masking data 160, to provide a stylized version of original surface mesh 222 having selected stylization 158 corresponding to style sample 126/226 (action 376). Stylization of original surface mesh 222, in action 376, may be performed by software code 110, executed by hardware processor 104 of system 100, and using style transfer ML model(s) 140/240, which, as noted above, may be or include one or more NNs, such as CNNs for example.

It is noted that the mesh style loss in Equation 1 is only defined for a single image and is therefore not temporally coherent. That is to say, directly optimizing Equation 1 produces patterns that abruptly change across different images. To implement temporal coherency efficiently, the present neural mesh stylization solution adopts the following approach: displacement contributions across multiple images are accumulated every time-step, which requires only a single alignment and smoothing step. For each t>0, this amounts to blending displacements with:

$${d}_{t} ← ( 1 - {γ}_{μ} ( α ) ) {d}_{t} + {γ}_{μ} ( α ) T ( {d}_{t - 1} , {u}_{t - 1} ) , \qquad ( Equation 5 )$$

where dₜ=\hat{x}ₜ*−xₜ* is the surface mesh displacement at timestep t and uₜ represents the vertex velocity of the animated surface mesh. the displacements are computed over the Laplacian reparametrized variable x*, which also further ensures smoothness in temporal coherency.

While previous exponential moving average-based (EMA-based) neural style transfer (NST) processing pipelines are able to produce temporally coherent stylizations for volumetric data, that conventional approach is found to produce sub-par results for mesh stylizations. The present neural mesh stylization solution improves upon the EMA-based NST approach through use of an iteration-aware function, Yu, that replaces the constant blending weight α. By adopting a linearly decaying function as iteration progresses, stylizations can be obtained that allow sharper synthesized patterns. The function

$${γ}_{μ} ( α ) = max ( α ( 1 - \frac{m}{μ} ) , 0 )$$

employs a decaying period factor μ that modulates the EMA smoothing weight according to the m-th iteration.

The [symbol] function uses the per-vertex velocities uₜ₋₁ to transport quantities defined over the surface mesh across subsequent images. The transport function is chosen to be the standard Semi-Lagrangian method defined as:

$$T ( {d}_{t} , {u}_{t} ) = I ( P ( {x}_{t}^{*} , {u}_{t} ) , {d}_{t - 1} ) , \qquad ( Equation 6 )$$

where [symbol] and I represent the position integration and interpolation functions, respectively. In contrast to previous volumetric approaches, an interpolation function for the displacements is not readily available for animated meshes. The present neural mesh stylization solution employ a Shepard interpolation, as known in the art, to continuously sample surface mesh displacements in space. For each vertex, a fixed neighborhood size of 50, for example, may be used for the interpolations.

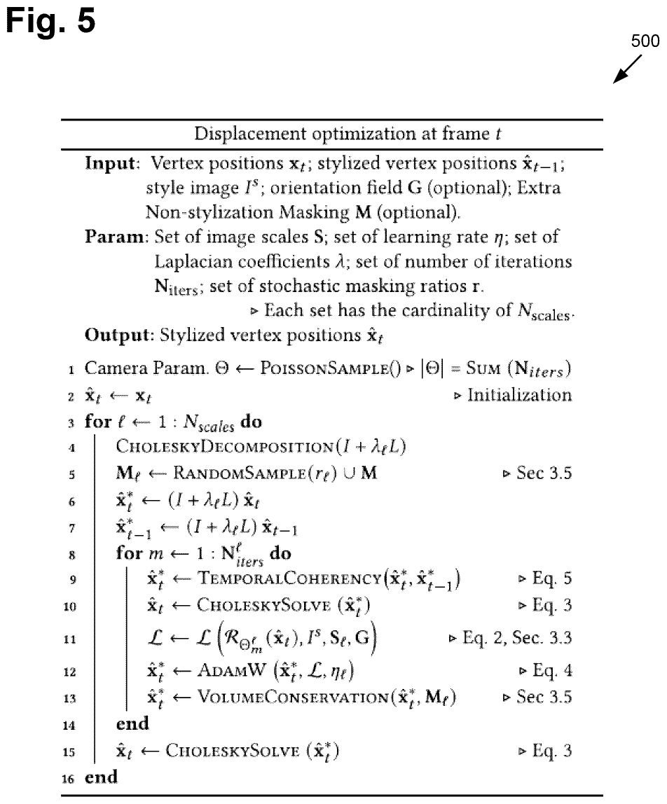

In some cases, neural mesh stylization may induce a prohibitive change of volume of the surface mesh, especially in thin regions of the surface mesh. To avoid this issue, at the start of each optimization scale, the present stylization solution initializes a random mask that covers a user-defined percentage of the vertices. These vertices are defined in the reparametrization performed in action 372 and they are kept from being displaced by the stylization. Due to the reparametrization, masked vertices influence their neighboring vertices, enabling a smooth transition from non-stylized to stylized regions. For the coarser scales, it is typically necessary for the mask to have to pin down vertices more aggressively to prevent volume loss. However, for the finest scales, no mask is necessary, since the stylization will mostly focus in creating small scale details that do not incur significant volume loss. Thus, stylizing the original surface mesh 222 to provide the stylized version of the original surface mesh having selected stylization 158 is performed subject to a volumetric constraint. Referring to FIG. 5, FIG. 5 presents exemplary pseudocode 500 of an algorithm for performing the controllable and temporally coherent neural mesh stylization described above by reference to flowchart 370, according to one implementation of the present novel and inventive concepts.

It is noted that once actions 371, 372, 373, 374 and 376, or actions 371, 372, 373, 374, 375 and 376 have been performed, hardware processor 104 of system 100 may further execute software code 110 to output image 168 corresponding to image 124, image 168 depicting the stylized version of original surface mesh 222. It is further noted that, in some implementations, actions 371, 372, 373, 374 and 376, or actions 371, 372, 373, 374, 375 and 376 may be performed in an automated process from which human involvement may be omitted.

Thus, the present application discloses systems and methods for performing controllable and temporally coherent neural mesh stylization that address and overcome the deficiencies in the conventional art. As noted above, the neural mesh stylization solution disclosed by the present application advances the state-of-the-art in several ways. First, the present solution replaces the conventional Gram-Matrix-based style loss by a neural neighbor formulation that provides sharper and artifact-free results. In order to support large mesh deformations, the mesh positions of an input mesh undergo view-independent reparametrization, according to the present solution, through an implicit formulation based on the Laplace-Beltrami operator to better capture silhouette gradients commonly present in inverse differentiable renderings. This view-independent reparametrization is coupled with a coarse-to-fine stylization, which enables deformations that can change large portions of the mesh. Furthermore, although artistic control is one of the often overlooked aspects of image-based stylization, the neural mesh stylization solution disclosed herein enables control over synthesized directional styles on the mesh by a guided vector field. This is achieved by augmenting the style loss with multiple orientations of the style sample, which are combined with a screen-space guiding field that spatially modulates which style direction should be used. In addition, the present solution improves conventional time-coherency schemes by developing an efficient regularization that controls volume changes during the stylization process. These improvements advantageously enable novel mesh stylizations that can create unique looks for simulations and 3-D assets.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a system memory storing a software code and a style transfer machine learning (ML) model;
the hardware processor configured to execute the software code to:
receive an image and a style sample of a selected stylization for an original surface mesh depicted by the image;
perform a view-independent reparametrization of the original surface mesh to provide a reparametrized surface mesh;
render a three-dimensional (3-D) representation of the reparametrized surface mesh;
generate, using a plurality of virtual cameras, a plurality of perspective images of the 3-D representation of the reparametrized surface mesh; and
stylize, using the style transfer ML model, the style sample and the plurality of perspective images of the 3-D representation of the reparametrized surface mesh, the original surface mesh, to provide a stylized version of the original surface mesh having the selected stylization.

2. The system of claim 1, wherein the hardware processor is further configured to execute the software code to:
output an image depicting the stylized version of the surface mesh.

3. The system of claim 1, wherein the style transfer ML model comprises a neural network (NN).

4. The system of claim 1, wherein the view-independent reparametrization of the original surface mesh is performed using a Laplace Beltrami operator.

5. The system of claim 1, wherein stylizing the original surface mesh to provide the stylized version of the original surface mesh having the selected stylization is performed subject to a volumetric constraint.

6. The system of claim 1, wherein the hardware processor is further configured to execute the software code to:
receive, from a system user, flow field data specifying a plurality of different planar orientations of the style sample;
wherein stylizing the original surface mesh to provide the stylized version of the original surface mesh having the selected stylization further uses the flow field data.

7. The system of claim 1, wherein the hardware processor is further configured to execute the software code to:
receive, from a system user, masking data identifying one or more masked regions of the surface mesh from which the selected stylization is to be omitted;
wherein stylizing the original surface mesh to provide the stylized version of the original surface mesh omits the selected stylization from the one or more masked regions of the surface mesh.

8. A method for use by a system including a hardware processor and a system memory storing a software code and a style transfer machine learning (ML) model, the method comprising:
receiving, by the software code executed by the hardware processor, an image and a style sample of a selected stylization for an original surface mesh depicted by the image;
performing a view-independent reparametrization of the original surface mesh, by the software code executed by the hardware processor, to provide a reparametrized surface mesh;
rendering, by the software code executed by the hardware processor, a three-dimensional (3-D) representation of the reparametrized surface mesh;
generating, by the software code executed by the hardware processor and using a plurality of virtual cameras, a plurality of perspective images of the 3-D representation of the reparametrized surface mesh; and
stylizing, by the software code executed by the hardware processor and using the style transfer ML model, the style sample and the plurality of perspective images of the 3-D representation of the reparametrized surface mesh, the original surface mesh, to provide a stylized version of the original surface mesh having the selected stylization.

9. The method of claim 8, further comprising:
outputting, by the software code executed by the hardware processor, an image depicting the stylized version of the surface mesh.

10. The method of claim 8, wherein the style transfer ML model comprises a neural network (NN).

11. The method of claim 8, wherein the view-independent reparametrization of the original surface mesh is performed using a Laplace Beltrami operator.

12. The method of claim 8, wherein stylizing the original surface mesh to provide the stylized version of the original surface mesh having the selected stylization is performed subject to a volumetric constraint.

13. The method of claim 8, further comprising:
receiving from a system user, by the software code executed by the hardware processor, flow field data specifying a plurality of different planar orientations of the style sample;
wherein stylizing the original surface mesh to provide the stylized version of the original surface mesh having the selected stylization further uses the flow field data.

14. The method of claim 8, further comprising:
receiving from a system user, by the software code executed by the hardware processor, masking data identifying one or more masked regions of the surface mesh from which the selected stylization is to be omitted;
wherein stylizing the original surface mesh to provide the stylized version of the original surface mesh omits the selected stylization from the one or more masked regions of the surface mesh.

15. A computer-readable non-transitory storage medium having stored thereon a software code and a style transfer machine learning (ML) model, wherein when executed by a hardware processor the software code instantiates a method comprising:
receiving an image and a style sample of a selected stylization for an original surface mesh depicted by the image;
performing a view-independent reparametrization of the original surface mesh to provide a reparametrized surface mesh;
rendering, a three-dimensional (3-D) representation of the reparametrized surface mesh;
generating, using a plurality of virtual cameras, a plurality of perspective images of the 3-D representation of the reparametrized surface mesh; and
stylizing, using the style transfer ML model, the style sample and the plurality of perspective images of the 3-D representation of the reparametrized surface mesh, the original surface mesh, to provide a stylized version of the original surface mesh having the selected stylization.

16. The computer-readable non-transitory storage medium of claim 15, the method further comprising:
outputting an image depicting the stylized version of the surface mesh.

17. The computer-readable non-transitory storage medium of claim 15, wherein the style transfer ML model comprises a neural network (NN).

18. The computer-readable non-transitory storage medium of claim 15, wherein the view-independent reparametrization of the original surface mesh is performed using a Laplace Beltrami operator.

19. The computer-readable non-transitory storage medium of claim 15, wherein stylizing the original surface mesh to provide the stylized version of the original surface mesh having the selected stylization is performed subject to a volumetric constraint.

20. The computer-readable non-transitory storage medium of claim 15, further comprising:
receiving at least one of flow field data specifying a plurality of different planar orientations of the style sample or, masking data identifying one or more masked regions of the surface mesh from which the selected stylization is to be omitted;
wherein stylizing the original surface mesh to provide the stylized version of the original surface mesh having the selected stylization further uses the at least one of the flow field data or the masking data.
